(19) United States
(12) Patent Application Publication
(10) Pub. No.: US 2013/0293146 A1
(43) Pub. Date: Nov. 7, 2013

(54) ILLUMINATION DEVICE HAVING DETERRENT FUNCTION

(71) Applicant: Ching-Nan Yang, New Taipei City (TW)

(72) Inventor: Ching-Nan Yang, New Taipei City (TW)

(21) Appl. No.: 13/462,832

(22) Filed: May 3, 2012

(51) Int. Cl. H05B 37/02

(52) U.S. Cl. 315/297

(57) ABSTRACT

The illumination device contains a number of lamps and deterrent modules. Each deterrent module contains a reception unit for receiving a wired or wireless signal, and is configured in a lamp. Each lamp has a lighting member electrically connected to the deterrent module. When the deterrent module are activated, based on their respective configured times and modes, the deterrent modules control the lighting members of the lamps to turn on or off or to adjust its brightness or to remain on or off for a period of time, so as to create an impression that there are people moving and living in the household.

### TECHNICAL FIELD OF THE INVENTION

The present invention is generally related to illumination devices, and more particularly to an illumination device capable of deterring burglars from breaking-in.

### DESCRIPTION OF THE PRIOR ART

When people are out of their houses usually keep at least a lamp on so that there is some basic illumination when they return home at night, or burglars would assume there are people in the house and therefore are deterred. However, lamps not turned off for a whole day sometimes attract burglars' attention, and this is also a waste of energy. As such, the so-called timed lamps are developed.

A timed lamp has a built-in clock. When a preset activation time is reached, the lamp is turned on automatically; when a preset shutdown time is reached, the lamp is turned off automatically. The timed lamp therefore provides a fixed interval of illumination. For a careful burglar or even a blunt burglar, the timed lamp still cannot provide appropriate deterrence.

### SUMMARY OF THE INVENTION

Therefore, a major objective of the present invention is to deter burglars from breaking into households.

To achieve the objective, the illumination device contains a number of lamps and deterrent modules. Each deterrent module contains a reception unit for receiving a wired or wireless signal, and is configured in a lamp. Each lamp has a lighting member electrically connected to the deterrent module. When the deterrent module are activated, based on their respective configured times and modes, the deterrent modules control the lighting members of the lamps to turn on or off or to adjust its brightness or to remain on or off for a period of time, so as to create an impression that there are people moving and living in the household.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing an illumination device according to an embodiment of the present invention.

FIG. 2 is a perspective diagram showing an illumination device according to another embodiment of the present invention.

FIGS. 3A to 3C show a scenario of a burglar being deterred by an illumination device of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

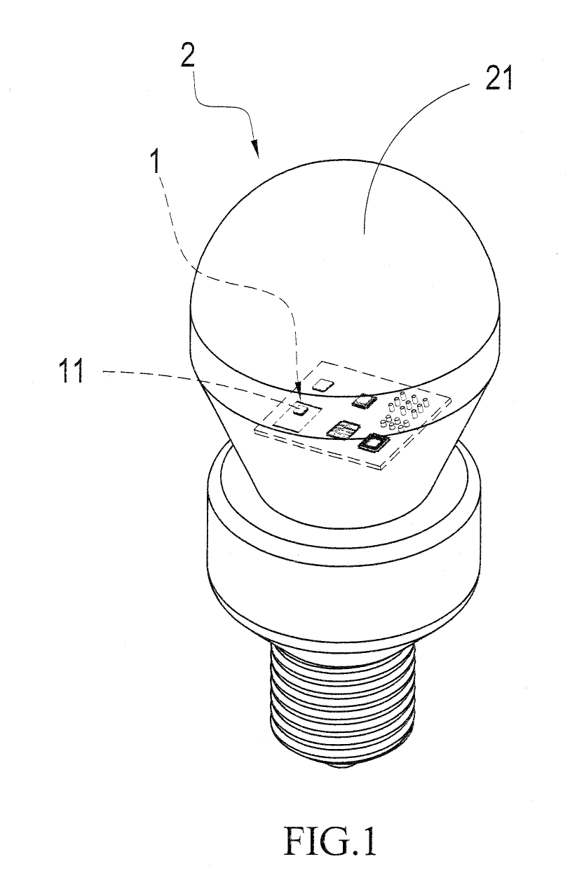

FIG. 1 shows an illumination device according to an embodiment of the present invention. The illumination device contains a lamp 2 which can be an incandescent light bulb, a fluorescent lamp tube, a LED light bulb, a LED lamp tube, a recessed lamp, etc. What is depicted in FIG. 1 is only an example and is not limited as such. The lamp 2 contains a lighting member 21 which is electrically connected to deterrent module 1 capable of control and switch the illumination and brightness of the lamp 2 in accordance with time. The deterrent module 1 can be a microcontroller or a similar computing device. The deterrent module 1 is configured inside the lamp 2 and contains a reception unit 11 for receiving a wired or wireless signal. The operation of the illumination device is as follows. When a wired or wireless signal is sent to the reception unit 11 and activates the deterrent module 1, the deterrent module 1, based on configured times and modes, controls the lighting member 21 of the lamp 2 to turn on or off or to adjust its brightness or to remain on or off for a period of time.

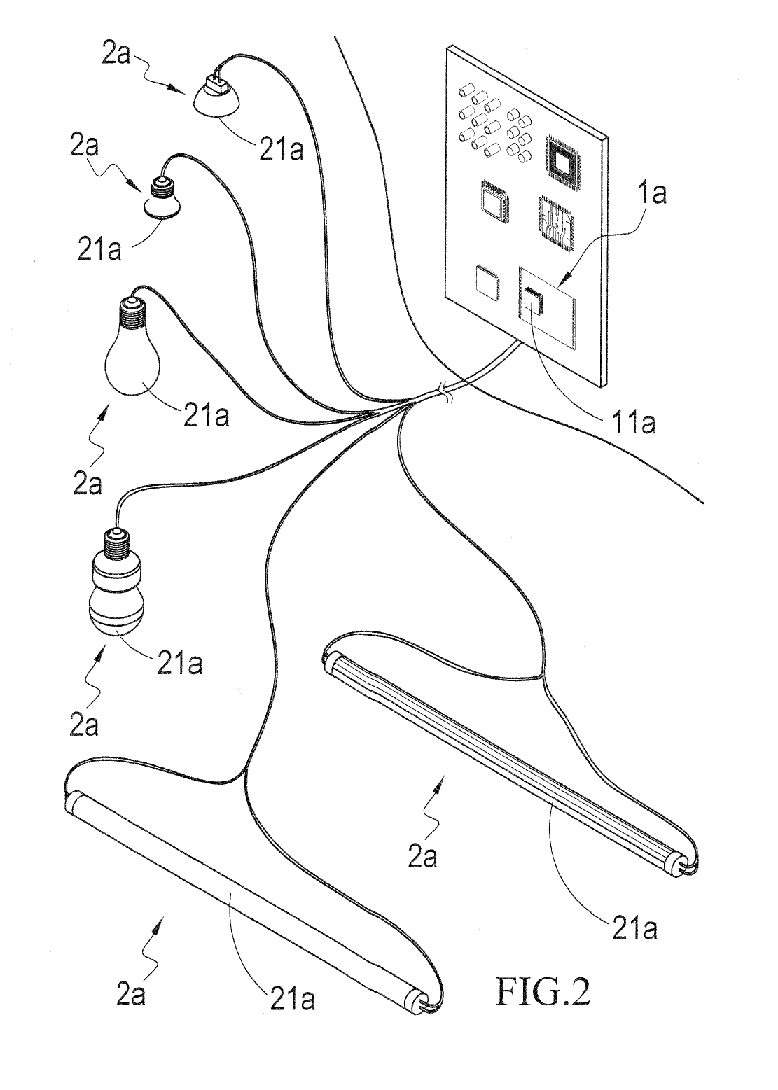

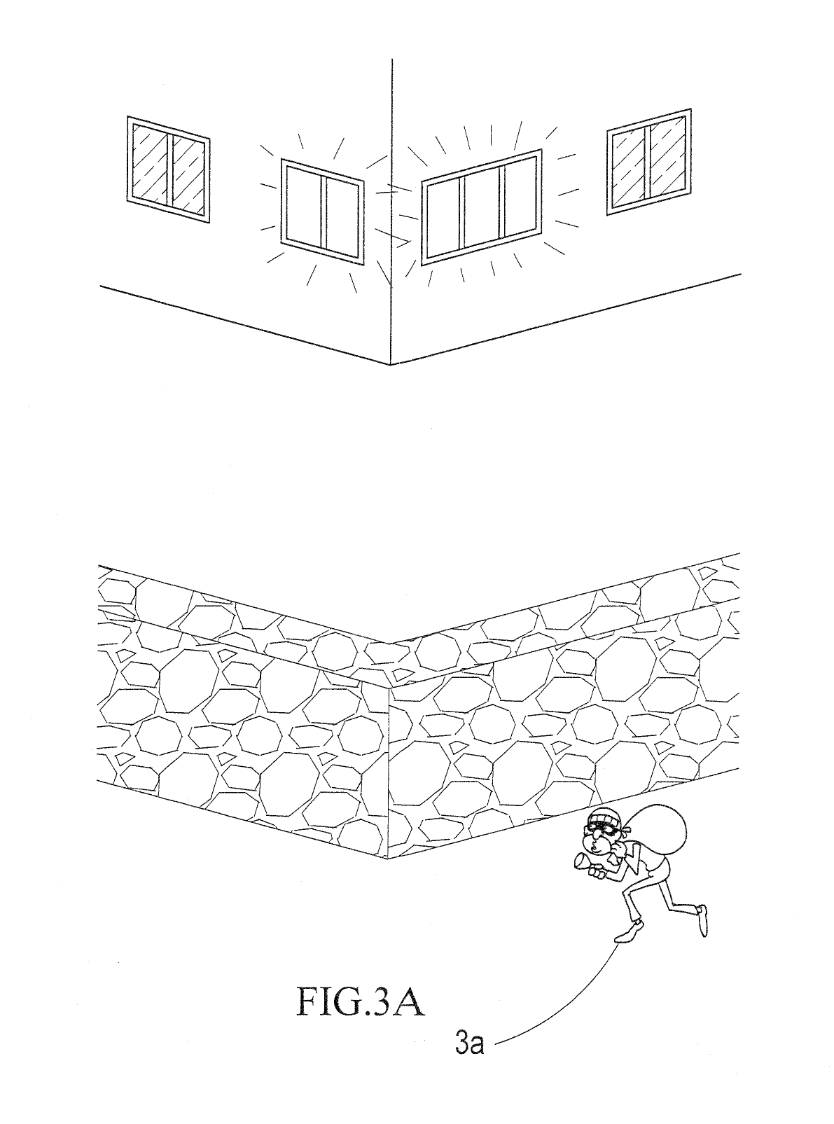

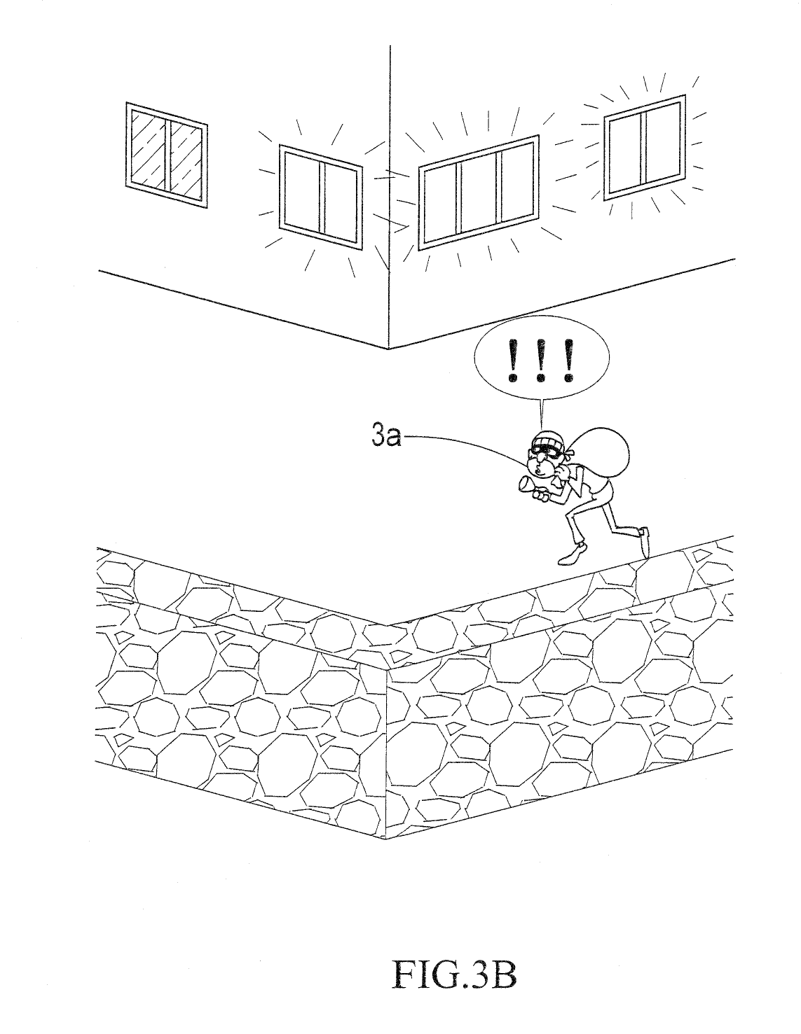

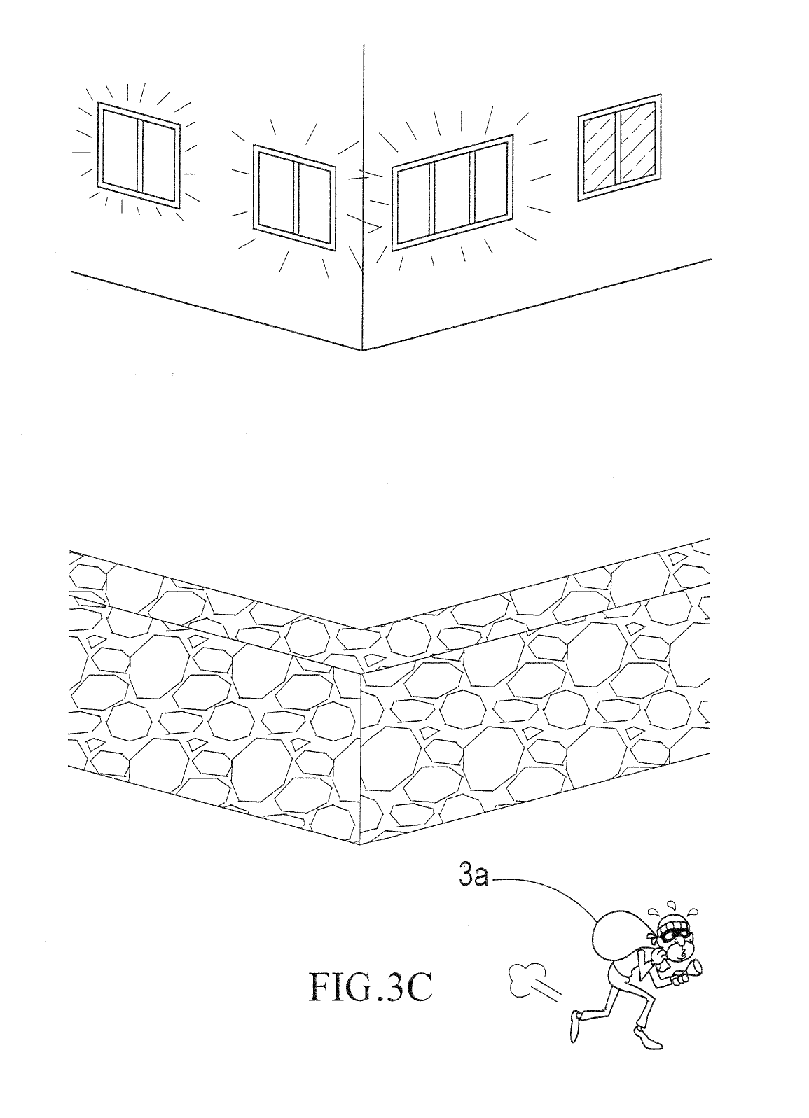

FIG. 2 shows an illumination device according to another embodiment of the present invention. The illumination device contains a number of lamps 2a which can be incandescent light bulbs, fluorescent lamp tubes, LED light bulbs, LED lamp tubes, recessed lamps, etc. What are depicted in FIG. 2 are only examples and the lamps 2a are not limited as such. Each lamp 2a contains a lighting member 21a, and all lighting members 21a are electrically connected to a separate deterrent module 1a capable of control and switch the illumination and brightness of the lamps 2a in accordance with time. The deterrent module 1a can be a microcontroller or a similar computing device. The deterrent module 1a contains a reception unit 11a for receiving a wired or wireless signal. The operation of the illumination device is as follows, together with FIGS. 3A to 3C. First, each room of a household can be configured with an illumination device of the present invention. When a wired or wireless signal is sent to a reception unit 11a and activates a deterrent module 1a, the deterrent module 1a, based on its configured times and modes, controls the lighting members 21 of the lamps 2a in a room to turn on or off or to adjust its brightness or to remain on or off for a period of time. Therefore, different rooms would reveal different lighting behaviors and, as such, an impression that people are moving around in the house is presented. For example, as shown in FIG. 3A, a burglar 3a would first spy on a house by monitoring the lights or shadows from the house's various rooms to see if there are people inside. Then, as shown in FIG. 3B, seeing the different lighting conditions from different rooms, the burglar 3a very possibly may give up his plan of breaking-in. Another application would be to configure the deterrent module 1a so that the lighting members 21a are dimmed during sleep hours (e.g., 1 AM to 6 AM). This is to simulate people's habit to switch to night light when going to bed. Therefore, an even more realistic impression could be created.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. An illumination device, comprising:
a lamp having a lighting member; and
a deterrent module inside the lamp electrically connected to the lighting member;
wherein the deterrent module, based on its configured times and
modes, controls the lighting member of the lamp to turn on or off, to
adjust brightness, or to remain on or off for a period of time.

2. The illumination device according to claim 1, wherein the deterrent module is a microcontroller.

3. The illumination device according to claim 1, wherein the deterrent module contains a reception unit for receiving a wired or wireless signal.

4. The illumination device according to claim 1, wherein the lamp is one of an incandescent light bulb, a fluorescent lamp tube, a LED light bulb, a LED lamp tube, and a recessed lamp.

5. An illumination device, comprising:
a plurality of lamps each having a lighting member; and
a separate deterrent module electrically connected to the lighting members of the lamps;
wherein the deterrent module, based on its configured times and
modes, controls the respective lighting members of the lamps to turn
on or off, to adjust brightness, or to remain on or off for a period of time.

6. The illumination device according to claim 5, wherein the deterrent module is a microcontroller.

7. The illumination device according to claim 5, wherein the deterrent module contains a reception unit for receiving a wired or wireless signal.

8. The illumination device according to claim 5, wherein each lamp is one of an incandescent light bulb, a fluorescent lamp tube, a LED light bulb, a LED lamp tube, and a recessed lamp.
